(19) United States
(12) Patent Application Publication
(10) Pub. No.: US 2016/0205056 A1
(43) Pub. Date: Jul. 14, 2016

(54) Method and system for automatic erasing repeated messages of an computerizes devices and systems

(71) Applicant: NURIT LEIZEROVICH, Lod (IL)

(72) Inventor: NURIT LEIZEROVICH, Lod (IL)

(21) Appl. No.: 14/594,183

(22) Filed: Jan. 12, 2015

(51) Int. Cl. H04L 12/58

(52) U.S. Cl. CPC H04L 51/22; H04L 51/12

(57) ABSTRACT

The present invention innovates in method and system for automatic, or semi-automatic erasing at list some parts from a repeated messages, or a repeated parts of messages in an computerizes devices, software and systems. Wherein, the present invention enabling such erasing in a computerizes messages, such as in an email written message for example, enabling an automatic erasing parts of the messages between two users or more, as in the method and the system of the present invention.

### FIELD of the INVENTION

This invention relates primarily to the practice of emailing and computerize messages, more specifically to a method and system for automatic erasing a repeated messages, or erasing a repeated parts of messages in computerizes devices, software and systems, wherein, such erasing enabled automatically, or semi-automatic by dedicated software's and system.

### BACKGROUND OF THE INVENTION

Electronic mail, commonly known as email or e-mail, is a method of exchanging digital messages from an author to one or more recipients.

Modern email operates across the Internet or other computer networks. Some early email systems required that the author and the recipient both be online at the same time, in common with instant messaging. Today's email systems are based on a store-and-forward model. Email servers accept, forward, deliver and store messages.

Neither the users nor their computers are required to be online simultaneously; they need connect only briefly, typically to an email server, for as long as it takes to send or receive messages.

An email message consists of three components, the message envelope, the message header, and the message body. The message header contains control information, including, minimally, an originator's email address and one or more recipient addresses. Usually descriptive information is also added, such as a subject header field and a message submission date/time stamp.

Such messages between participants enabled a continuant messages, wherein, the last message copies the previous messages, for example whenever a user forwarding “replay” on a previous messages excepted before, showing in the chaining correspond exchange between at list two users for few times repeatedly, wherein, the present invention method enabling by computerized system and dedicated software's designated to recognized these duplication for example, and to erases the repeated written, or to save it in another section of the computer.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

The present invention innovates in method and system for automatic, or semi-automatic erasing at list parts of a repeating messages, or a repeated parts of messages in an computerizes devices, software and systems.

wherein, the present invention enabling in a computerizes messages, such as an email written message for example, an automatic erasing system that enabling to erase parts of the messages between two users or more, for example.

Wherein, such erased parts from the messages are these parts which repeated at list two times between the participants.

Such repeated parts for example, happened when one user replying to a written message that is in his e-mail box for example, and then, the first written message is showing again in the chaining correspond exchange between at list two users for few times repeatedly.

Wherein, the present invention method enabling by computerized system and dedicated software's to recognized these duplication for example, and to erases the repeated written, or to choose another options, such as to save these duplication in another section.

Wherein, such messages between participants enabled the latest message together with the lasts message or even with all the chaining correspond exchange,

Wherein the last message copies the previous messages, for example, whenever a user forwarding “replay” on a previous messages accepted before, showing in the chaining correspond exchange between at list two users for few times repeatedly, wherein, the present invention method enabling by computerized system and dedicated software's designated to recognized these duplication for example, and to erases the repeated written, or to save it in another section of the computer.

### DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the description of the embodiments set forth below is to be regarded as illustrative in nature and not restrictive.

The present invention innovates method and system for automatic, or semi-automatic erasing of a repeated messages parts, or a repeated parts of messages in a computerizes devices, software and systems. Wherein, the present invention enabling in a computerizes messages, such as an email written message for example, an automatic erasing parts of the messages between two users or more, for example, such erased parts of the messages are these who repeated at list two times between the users, such as, for example, when one user replying to a written message, and the first written message is showing in the chaining correspond exchange between at list two users for few times repeatedly. Wherein, the present invention method enabling by computerized system and dedicated software's to recognized these duplication for example, and to erases the repeated written, or to save it.

Wherein, such messages between participants enabled a continuant messages, wherein the last message copies the previous messages, for example whenever a user forwarding “replay” on a previous messages excepted before, showing in the chaining correspond exchange between at list two users for few times repeatedly, wherein, the present invention method enabling by computerized system and dedicated software's designated to recognized these duplication for example, and to erases the repeated written, or to save it in another section of the computer.

Wherein such erasing can be preformed upon the repeated parts of the message in time it exiting to the recipient computer, or optionally it the time it is recognizes the repeated parts of the message before accepting them to the recipient computer, or optionally erasing these parts after they being accepting into one of the computerized systems.

Wherein, such method and system fitted to be performed in computerized device, such as in portable smart telephones, and in all kind of computers.

1. A method for automatic, or semi-automatic erasing of a repeated written messages parts, or a repeated written parts of messages in an computerizes devices, software and systems, wherein, the present method enabling in a computerizes messages, such as an email written message for example, an automatic erasing parts of the messages between two users or more, for example, such erased parts of the messages are these who repeated at list two times between the users, such as, for example, when one user replying to a written message, and the first written message is showing in the chaining correspond exchange between at list two users for few times repeatedly; wherein, the present invention method enabling by computerized system and dedicated software's to recognized these duplication for example, and to erases the repeated written, or to save it.

2. System and dedicated software's for enabling in a computerized devices an automatic, or semi-automatic erasing of a repeated written messages parts, or a repeated parts of messages, wherein, the present system and dedicated software's enabling in a computerizes messages, such as an email written message for example, an automatic erasing parts of the messages between two users or more, for example, such erased parts of the messages are these who repeated at list two times between such users, such as, for example, when one user replying to a written message, and the first written message is showing in the chaining correspond exchange between at list two users for few times repeatedly, wherein, the present invention and dedicated software's enabling to recognized these written duplication for example, and to erases the repeated written, or to save it.

3. Claim as in claims 1 and 2, wherein such erasing of repeated message or parts of messages can be preformed upon the message in time it arriving to the recipient computer, or optionally at the time it is recognizes the repeated written parts of the message before accepting them to the recipient computer, or optionally erasing these parts after they being accepting into one of the computerized systems.
